(19) United States
(12) Patent Application Publication
(10) Pub. No.: US 2024/0088648 A1
(43) Pub. Date: Mar. 14, 2024

(54) LEAKAGE CURRENT CONTROL DEVICE AND RELATED CONTROL APPARATUS AND ELECTRICAL APPLIANCE EMPLOYING THE SAME

(71) Applicant: Chengli LI, Suzhou (CN)

(72) Inventors: Aijun YANG, Suzhou (CN); Erjian SONG, Suzhou (CN)

(73) Assignee: Chengli LI, Suzhou (CN)

(21) Appl. No.: 18/048,788

(22) Filed: Oct. 21, 2022

(30) Foreign Application Priority Data
Sep. 14, 2022 (CN) 202211114399.7

(51) Int. Cl. H02H 9/02

(52) U.S. Cl. CPC H02H 9/02

(57) ABSTRACT

A leakage current control device includes first and second current limiting elements coupled in series between input and output ends, and a voltage detection and selection unit, which has its first end coupled to the input end, its second end coupled to a point between the first and second current limiting elements, and its third end coupled to the output end. The voltage detection and selection unit detects whether the input end is in a first or second power supply state, and correspondingly, either controls the second current limiting element to operate, or bypasses the second current limiting element. As a result, the leakage current between the input and output ends is limited to within required threshold ranges under both conditions. This device can effectively limit the leakage current under a wide input voltage range without unduly reducing the power supplied to the downstream appliance.

### BACKGROUND OF THE INVENTION

### Field of the Invention

This invention relates to electrical appliances, and in particular, it relates to a device for limiting leakage current in a power supply for an appliance, related control apparatus, and electrical appliance employing such control device and apparatus.

### Description of Related Art

With the wide use of home electrical appliances, safety of such appliances is important. In the area of electrical switches, to meet market demand, for switches that allow a relatively wide input voltage range and that are used in a current path formed between a hot line and a ground line, such as a light switch, its leakage current under different voltages are often quite different. Various certification tests have requirements regarding the leakage current parameter. In applications involving relatively low input voltages, leakage currents are relatively easy to control, but in applications involving relatively high input voltages, there is a possibility that the leakage current will be too large and the device cannot pass the certification test.

In currently technology, to overcome this problem, a resistor with a relatively large resistance is coupled in series in the current path, to limit the leakage current under high input voltages. However, this technique has the problem that, in situations involving relatively low input voltages, the power supplied to the appliance is reduced, which can sometimes potentially interfere with the normal function of the appliances.

### SUMMARY

Therefore, there is a need for a device for controlling and limiting leakage current (a leakage current control device) that can achieve the control effect over a wide range of input voltages, to ensure that the leakage current is within the range required by the certifications, and to ensure the proper function and safety of the appliance.

To achieve the above objects, the present invention provides a leakage current control device, which includes: a first current limiting element, having one end coupled to an input end of the device; a second current limiting element, having one end coupled in series with another end of the first current limiting element, and another end coupled to an output end of the device; and a voltage detection and selection unit, having a first end coupled to the input end, a second end coupled to a point between the first and second current limiting elements, and a third end coupled to the output end, wherein the voltage detection and selection unit is configured to detect whether the input end is in a first power supply state, and in response to the input end being in the first power supply state, to control the second current limiting element to operate, wherein the first current limiting element and the second current limiting element operate to limit a leakage current between the input end and the output end to within a first threshold range.

In some embodiments, the voltage detection and selection unit is further configured to detect whether the input end is in a second power supply state, and in response to the input end being in the second power supply state, to control the second current limiting element to cease to operate, wherein the first current limiting element operates to limit the leakage current to within a second threshold range.

In some embodiments, the voltage detection and selection unit includes:
a voltage detection circuit, coupled between the input end and the output end, configured to detect whether the input end is in the first or the second power supply state; and
a selection circuit, coupled between the input end and output end, and coupled to the voltage detection circuit, configured to: in response to the voltage detection circuit detecting that the input end is in the first power supply state, control the second current limiting element to operate, wherein the first current limiting element and the second current limiting element operate to limit the leakage current to within the first threshold range, and in response to the voltage detection circuit detecting that the input end is in the second power supply state, control the second current limiting element to cease to operate, wherein the first current limiting element operates to limit the leakage current to within the second threshold range.

In some embodiments, the voltage detection circuit includes:
a first voltage divider resistor, having one end coupled to the input end;
a second voltage divider resistor, having one end coupled in series with another end of the first voltage divider resistor, and another end coupled to the output end; and
a first semiconductor device, having a first end coupled to a point between the first and second voltage divider resistors, a second end coupled to the output end, and a third end coupled to the selection circuit,
wherein when the input end is in the first power supply state, the first and second voltage divider resistors generate a divided voltage which controls the first semiconductor device to be conductive, and when the input end is in the second power supply state, the first and second voltage divider resistors generate another divided voltage which controls the first semiconductor device to be non-conductive.

In some embodiments, the selection circuit includes:
a third voltage divider resistor, having one end coupled to the input end, and another end coupled to the third end of the first semiconductor device;
a fourth voltage divider resistor, having one end coupled in series with another end of the third voltage divider resistor, and another end coupled to the output end; and
a second semiconductor device, having a first end coupled to a point between the third and fourth voltage divider resistors, a second end coupled to the output end, and a third end coupled to a point between the first current limiting element and the second current limiting element,
wherein when the input end is in the first power supply state, the third voltage divider resistor is shorted which controls the second semiconductor device to be non-conductive, wherein the first current limiting element and the second current limiting element operate to limit the leakage current to within the first threshold range, and when the input end is in the second power supply state, the third and fourth voltage divider resistors generate a divided voltage which controls the second semiconductor device to be conductive, which shorts the second current limiting element, wherein the first current limiting element operates to limit the leakage current to within the second threshold range.

In some embodiments, the first semiconductor device is either a bipolar transistor or a field-effect transistor, and the second semiconductor device is either a bipolar transistor or a field-effect transistor.

In some embodiments, the first semiconductor device is a field-effect transistor and the second semiconductor device is a bipolar transistor.

In some embodiments, the voltage detection circuit further includes a first capacitor, coupled in parallel with the second voltage divider resistor, configured to delay a timing of the first semiconductor device becoming conductive when the input end enters the first power supply state.

In some embodiments, the selection circuit further includes a second capacitor, coupled in parallel with the fourth voltage divider resistor, configured to delay a timing of the second semiconductor device becoming conductive when the input end enters the second power supply state.

In another aspect, the present invention provides an electrical power control device, which includes: a body; and the leakage current control device according to any of the above embodiments, disposed inside the body.

In yet another aspect, the present invention provides an electrical appliance, which includes: an electrical load; and an electrical power control device coupled between a power supply and the load to control a power supplied to the load, wherein the electrical power control device includes the leakage current control device according to any of the above embodiments.

### BRIEF DESCRIPTION OF THE DRAWINGS

Preferred embodiments of the present invention are described with reference to the drawings. These drawings serve to explain the embodiments and their operating principle, and only illustrate structures that are necessary to the understanding of the principles of the invention. These drawings are not necessarily to scale. In the drawings, like features are designated by like reference symbols.

FIG. 1 is a block diagram of a leakage current control device according to an embodiment of the present invention.

FIG. 2 is a circuit diagram of a leakage current control device according to another embodiment of the present invention.

### DETAILED DESCRIPTION OF PREFERRED EMBODIMENTS

Preferred embodiments of the present invention are described below with reference to the drawings. These drawings and descriptions explain embodiments of the invention but do not limit the invention. The described embodiments are not all possible embodiments of the present invention. Other embodiments are possible without departing from the spirit and scope of the invention, and the structure and/or logic of the illustrated embodiments may be modified. Thus, it is intended that the scope of the invention is defined by the appended claims.

In the descriptions below, terms such as “including” are intended to be open-ended and mean “including without limitation”, and can include other contents. “Based on” means “at least partly based on.” “An embodiment” means “at least one embodiment.” “Another embodiment” means “at least another embodiment,” etc.

A technical problem addressed by the leakage current control device according to embodiments of the present invention is, in different applications involving a wide range of input voltages, how to ensure that the leakage current of the electrical appliance is limited to below the required threshold values, to ensure the proper function and safety of the electrical appliance.

To solve the above problem, according to an embodiment of the present invention, a leakage current control device includes a first current limiting element, a second current limiting element, and a voltage detection and selection unit. The first current limiting element is coupled at one end to the input end (which may be coupled to the power supply lines), and coupled in series at the other end to one end of the second current limiting element. The other end of the second current limiting element is coupled to an output end (which may be coupled to the downstream electrical appliance). The voltage detection and selection unit has its first end coupled to the input end, its second end coupled to a point between the first and second current limiting elements, and its third end coupled to the output end. The voltage detection and selection unit is configured to detect whether the input end is in a first power supply state, and when the input end is in the first power supply state, to control the second current limiting element to operate so as to limit the leakage current to within a first threshold range.

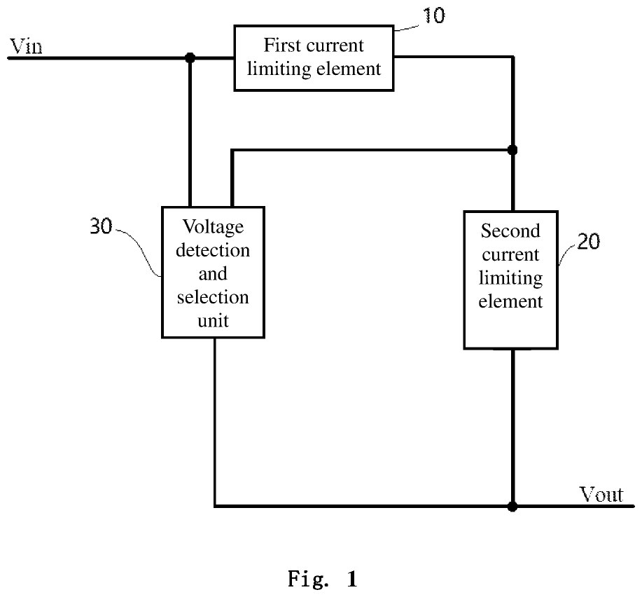

FIG. 1 schematically illustrates the structure of a leakage current control device according to an embodiment of the present invention. As shown in FIG. 1, the leakage current control device includes a first current limiting element 10, a second current limiting element 20, and a voltage detection and selection unit 30. The first and second current limiting elements 10 and 20 are coupled in series between the input end Vin and output end Vout. The voltage detection and selection unit 30 has its first end coupled to the input end Vin, its second end coupled to a point between the first and second current limiting elements 10 and 20, and its third end coupled to the output end Vout.

The voltage detection and selection unit 30 is configured to detect whether the input end Vin is in a first power supply state, and when the input end Vin is in the first power supply state, to control the second current limiting element 20 to operate, so as to limit the leakage current (the current that flows between the input and output ends) to within a first threshold range. The voltage detection and selection unit 30 is further configured to detect whether the input end Vin is in a second power supply state, and when the input end Vin is in the second power supply state, to control the second current limiting element to cease operation, so as to limit the leakage current to within a second threshold range. Optionally, the first and second threshold ranges may be the same or different.

More specifically, when the input voltage at the input end Vin is relatively high (e.g., 210V-270V), the voltage detection and selection unit 30 detects that the leakage current control device is under a first power supply state, and in response thereto, controls both the first and second current limiting elements 10 and 20 to operate simultaneously. As a result, the leakage current is limited to within the first threshold range. On the other hand, when the input voltage at the input end Vin is relatively low (e.g., 90V-130V), the voltage detection and selection unit 30 detects that the leakage current control device is under a second power supply state, and in response thereto, controls the second current limiting element 20 to not operate and only the first current limiting element 10 to operate. As a result, the leakage current is limited to within the second threshold range.

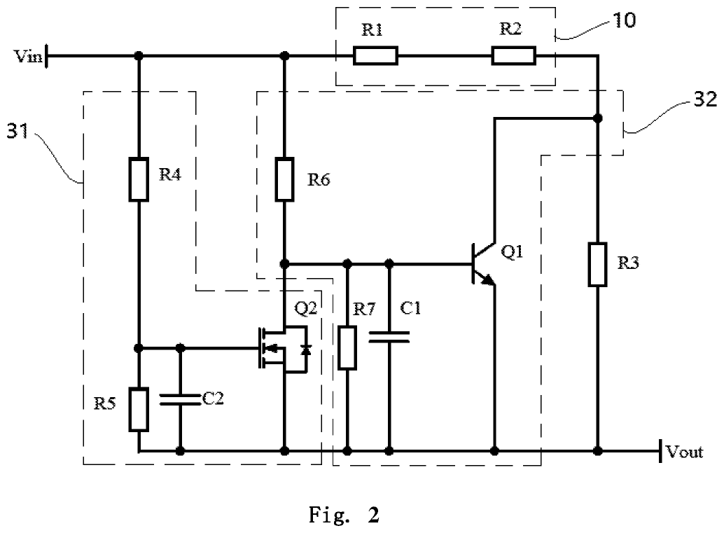

FIG. 2 shows a circuit diagram of the leakage current control device according to an embodiment of the present invention. In FIG. 2, the first current limiting element 10 includes two serial-coupled resistors R1 and R2, the second current limiting element 20 includes a resistor R3, and the voltage detection and selection unit 30 includes a voltage detection circuit 31 and a selection circuit 32. The voltage detection circuit 31 is coupled between the input end Vin and output end Vout. The selection circuit 32 is coupled between the input end Vin and output end Vout and also coupled to the voltage detection circuit 31.

The voltage detection circuit 31 includes first and second voltage divider resistors R4 and R5, a first semiconductor device Q2, and a first capacitor C2. The first and second voltage divider resistors R4 and R5 are coupled in series between the input end Vin and output end Vout. The first capacitor C2 is coupled in parallel with the second voltage divider resistor R5. In the illustrated embodiment, the first semiconductor device Q2 is a field-effect transistor (FET), with its gate coupled to the point between the first and second voltage divider resistors R4 and R5, and its source coupled to the output end Vout.

The selection circuit 32 includes third and fourth voltage divider resistors R6 and R7, a second semiconductor device Q1, and a second capacitor C1. The third and fourth voltage divider resistors R6 and R7 are coupled in series between the input end Vin and output end Vout. The drain of the first semiconductor device Q2 is coupled to the point between third and fourth voltage divider resistors R6 and R7. The second capacitor C1 is coupled in parallel with the fourth voltage divider resistor R7. In the illustrated embodiment, the second semiconductor device Q1 is a bipolar transistor, with its base coupled to the point between the third and fourth voltage divider resistors R6 and R7, its emitter coupled to the output end Vout, and its collector coupled to the point between resistors R2 and R3.

Alternatively, in practice, the first semiconductor device Q2 may be either a bipolar transistor or a FET, and the second semiconductor device Q1 may be either a bipolar transistor or a FET.

An FET, as a voltage-controlled current device, can generate a relatively small leakage current as compared to a bipolar transistor. A bipolar transistor, as a current-controlled current device, can generate a relatively large leakage current as compared to a FET. Based on consideration of the relative cost and effectiveness of the choice of components (FETs are more costly, but have superior control effect, than bipolar transistors), in the illustrated embodiment, the first semiconductor device Q2 is a FET and the second semiconductor device Q1 is a bipolar transistor.

The operation principles of the leakage current control device of FIGS. 1 and 2 are as follows.

When the input end Vin is in the first power supply state, the divided voltage generated by the first and second voltage divider resistors R4 and R5 controls the first semiconductor device Q2 to be conductive (i.e. Q2 is turned on). Thus, the fourth voltage divider resistor R7 is shorted, so the voltage at the point between the third and fourth voltage divider resistors R6 and R7 cannot control the second semiconductor device Q1 to be conductive. In this state, resistors R1, R2 and R3 are connected in series to form a current path, and the leakage current in this current path is limited to within the first threshold range.

When the input end Vin is in the second power supply state, the divided voltage generated by the first and second voltage divider resistors R4 and R5 is insufficient to turn on the first semiconductor device Q2 (i.e. Q2 remains off or non-conductive). As the first semiconductor device Q2 does not short resistor R7, the third and fourth voltage divider resistors R6 and R7 generate a divided voltage which controls the second semiconductor device Q1 to be conductive. As a result, resistor R3 is shorted, and the leakage current in the resulting current path (R1 and R2) is limited to within the second threshold range.

In this embodiment, the first capacitor C2 functions to delay the timing of the first semiconductor device Q2 becoming conductive when the input end Vin enters the first power supply state, and the second capacitor C1 functions to delay the timing of the second semiconductor device Q1 becoming conductive when the input end Vin enters the second power supply state. These capacitors C2 and C1 ensure that the downstream electrical appliance connected to the leakage current control device can be more reliably and more stably operated.

In some practical applications (e.g., when cost is a concern), the first and second capacitors C2 and C1 may be omitted.

In the illustrated embodiments, the first current limiting element 10 includes two resistors R1 and R2 in order to facilitate heat dissipation from the resistors during operation, which prolongs the life of the device.

In some practical applications (e.g., when cost is a concern), the first current limiting element 10 may include only one resistor to perform the function of controlling the leakage current.

In the leakage current control device according to embodiments of the present invention, by automatically selecting different current-limiting modes based on detection of the input voltage, the leakage current can be limited to within predetermined threshold ranges under different input voltages, and the power supplied to the downstream appliance can also be maintained in predetermined ranges, thereby ensuring the proper function and safety of the appliance.

Some additional embodiments of the present invention provide an electrical power control device, which includes a body and a leakage current control device according to any of the above embodiments disposed inside the body.

Other additional embodiments of the present invention provide an electrical appliance, which includes an electrical load and an electrical power control device coupled between a power supply and the load to control a power supplied to the load, where the electrical power control device employs a leakage current control device according to any of the above embodiments.

While the present invention is described above using specific examples, these examples are only illustrative and do not limit the scope of the invention. It will be apparent to those skilled in the art that various modifications, additions and deletions can be made to the leakage current control device of the present invention without departing from the spirit or scope of the invention.

What is claimed is:

1. A leakage current control device, comprising:
a first current limiting element, having one end coupled to an input end of the device;
a second current limiting element, having one end coupled in series with another end of the first current limiting element, and another end coupled to an output end of the device; and
a voltage detection and selection unit, having a first end coupled to the input end, a second end coupled to a point between the first and second current limiting elements, and a third end coupled to the output end,
wherein the voltage detection and selection unit is configured to detect whether the input end is in a first power supply state, and in response to the input end being in the first power supply state, to control the second current limiting element to operate, wherein the first current limiting element and the second current limiting element operate to limit a leakage current between the input end and the output end to within a first threshold range.

2. The leakage current control device of claim 1, wherein the voltage detection and selection unit is further configured to detect whether the input end is in a second power supply state, and in response to the input end being in the second power supply state, to control the second current limiting element to cease to operate, wherein the first current limiting element operates to limit the leakage current to within a second threshold range.

3. The leakage current control device of claim 2, wherein the voltage detection and selection unit includes:
a voltage detection circuit, coupled between the input end and the output end, configured to detect whether the input end is in the first or the second power supply state; and
a selection circuit, coupled between the input end and output end, and coupled to the voltage detection circuit, configured to: in response to the voltage detection circuit detecting that the input end is in the first power supply state, control the second current limiting element to operate, wherein the first current limiting element and the second current limiting element operate to limit the leakage current to within the first threshold range, and in response to the voltage detection circuit detecting that the input end is in the second power supply state, control the second current limiting element to cease to operate, wherein the first current limiting element operates to limit the leakage current to within the second threshold range.

4. The leakage current control device of claim 3, wherein the voltage detection circuit includes:
a first voltage divider resistor, having one end coupled to the input end;
a second voltage divider resistor, having one end coupled in series with another end of the first voltage divider resistor, and another end coupled to the output end; and
a first semiconductor device, having a first end coupled to a point between the first and second voltage divider resistors, a second end coupled to the output end, and a third end coupled to the selection circuit,
wherein when the input end is in the first power supply state, the first and second voltage divider resistors generate a divided voltage which controls the first semiconductor device to be conductive, and when the input end is in the second power supply state, the first and second voltage divider resistors generate another divided voltage which controls the first semiconductor device to be non-conductive.

5. The leakage current control device of claim 4, wherein the selection circuit includes:
a third voltage divider resistor, having one end coupled to the input end, and another end coupled to the third end of the first semiconductor device;
a fourth voltage divider resistor, having one end coupled in series with another end of the third voltage divider resistor, and another end coupled to the output end; and
a second semiconductor device, having a first end coupled to a point between the third and fourth voltage divider resistors, a second end coupled to the output end, and a third end coupled to a point between the first current limiting element and the second current limiting element,
wherein when the input end is in the first power supply state, the third voltage divider resistor is shorted which controls the second semiconductor device to be non-conductive, wherein the first current limiting element and the second current limiting element operate to limit the leakage current to within the first threshold range, and when the input end is in the second power supply state, the third and fourth voltage divider resistors generate a divided voltage which controls the second semiconductor device to be conductive, which shorts the second current limiting element, wherein the first current limiting element operates to limit the leakage current to within the second threshold range.

6. The leakage current control device of claim 5, wherein the first semiconductor device is either a bipolar transistor or a field-effect transistor, and the second semiconductor device is either a bipolar transistor or a field-effect transistor.

7. The leakage current control device of claim 6, wherein the first semiconductor device is a field-effect transistor and the second semiconductor device is a bipolar transistor.

8. The leakage current control device of claim 4, wherein the voltage detection circuit further includes a first capacitor, coupled in parallel with the second voltage divider resistor, configured to delay a timing of the first semiconductor device becoming conductive when the input end enters the first power supply state.

9. The leakage current control device of claim 5, wherein the selection circuit further includes a second capacitor, coupled in parallel with the fourth voltage divider resistor, configured to delay a timing of the second semiconductor device becoming conductive when the input end enters the second power supply state.

10. An electrical power control device, comprising:
a body; and
the leakage current control device of claim 1, disposed inside the body.

11. An electrical appliance, comprising:
an electrical load; and
an electrical power control device coupled between a power supply and the load to control a power supplied to the load, wherein the electrical power control device includes the leakage current control device of claim 1.
